(19) United States
(12) Patent Application Publication
(10) Pub. No.: US 2016/0281305 A1
(43) Pub. Date: Sep. 29, 2016

(54) CONVEYOR SYSTEM FOR COLD PLANER

(71) Applicant: Caterpillar Paving Products Inc., Brooklyn Park, MN (US)

(72) Inventor: Alan Hsieh, Brooklyn Park, MN (US)

(73) Assignee: Caterpillar Paving Products Inc., Brooklyn Park, MN (US)

(21) Appl. No.: 15/176,613

(22) Filed: Jun. 8, 2016

(51) Int. Cl. E01C 23/088; B65G 21/10; E01C 23/12; B65G 15/24

(52) U.S. Cl. CPC E01C 23/088; B65G 15/24; B65G 21/10; E01C 23/127

(57) ABSTRACT

A cold planer has a conveyor system which includes a conveyor frame adapted to receive a conveyor belt. The conveyor frame includes a first portion of the conveyor frame coupled to an anti-slab mechanism. The first portion of the conveyor frame undergoes a change in position corresponding to a movement of the anti-slab mechanism. The conveyor frame includes a second portion of the conveyor frame. The second portion of the conveyor frame has a throw-off end to release a material being conveyed on the conveyor system. The conveyor frame further includes a hinge mechanism located between the first portion of the conveyor frame and the second portion of the conveyor frame. The hinge mechanism allows the throw-off end of the second portion to remain at a fixed position corresponding to the movement of the anti-slab mechanism.

### TECHNICAL FIELD

The present disclosure relates to a cold planer. More specifically, the present disclosure relates to a conveyor system of the cold planer.

### BACKGROUND

Asphalt-surfaced roadways are built to facilitate vehicular travel. Depending upon usage density, base conditions, temperature variation, moisture variation, and/or physical age, the surface of the roadways eventually become misshapen, non-planar, unable to support wheel loads, or otherwise unsuitable for vehicular traffic. In order to rehabilitate the roadways for continued vehicular use, spent asphalt is removed in preparation for resurfacing.

Cold planers, sometimes also called road mills or scarifiers, are machines that typically include a frame propelled by tracked drive units. The frame supports an engine, an operator's station, and a milling drum. The milling drum, fitted with cutting tools, is rotated through a suitable interface by the engine to break up the surface of the roadway. The broken up roadway material is deposited by the milling drum onto a lower or primary conveyor for removal from the underside of the machine. The primary conveyor may have a lower end to receive the material and transfer to an upper end. The material is then transferred from the upper end of the primary conveyor onto a secondary conveyor. The secondary conveyor transports the material away from the machine and over a nearby haul truck. The material travels up the secondary conveyor and falls off the end into the haul truck for transportation away from the jobsite.

As the process of breaking up the surface of the roadway advances, a depth of cut of the rotor may need to be increased. To increase the depth of cut, a side plates and an anti-slab are moved upwards so that the rotor can have access to a larger surface area of the roadway. As the anti-slab mechanism is coupled to the lower end of the primary conveyor, the lower end of the primary conveyor needs to move up. The movement of the lower end causes the upper end of the primary conveyor to move and creates a gap between the upper end of primary conveyor and the secondary conveyor and subsequently poses sealing difficulties for transferring the material between the primary and secondary conveyors.

Thus, an improved conveyor system is required to accommodate the movement of primary conveyor without compromising with the efficiency of the conveyor system.

### SUMMARY

In an aspect of the present disclosure, a cold planer having a conveyor system is provided. The conveyor system includes a conveyor frame adapted to receive a conveyor belt. The conveyor frame includes a first portion of the conveyor frame coupled to an anti-slab mechanism. The first portion of the conveyor frame undergoes a change in position corresponding to a movement of the anti-slab mechanism. The conveyor frame includes a second portion of the conveyor frame. The second portion of the conveyor frame has a throw-off end to release a material being conveyed on the conveyor system. The conveyor frame further includes a hinge mechanism located between the first portion of the conveyor frame and the second portion of the conveyor frame. The hinge mechanism allows the throw-off end of the second portion to remain at a fixed position corresponding to the movement of the anti-slab mechanism.

### BRIEF DESCRIPTION OF DRAWINGS

FIG. 1 shows a cold planer having a conveyor system, in accordance with an embodiment of the present disclosure;

FIG. 2 shows a primary conveyor along with a milling system and an anti-slabbing mechanism in a first position, in accordance with an embodiment of the present disclosure; and

FIG. 3 shows the primary conveyor along with the milling system and the anti-slabbing mechanism of FIG. 2 in a second position, in accordance with an embodiment of the present disclosure.

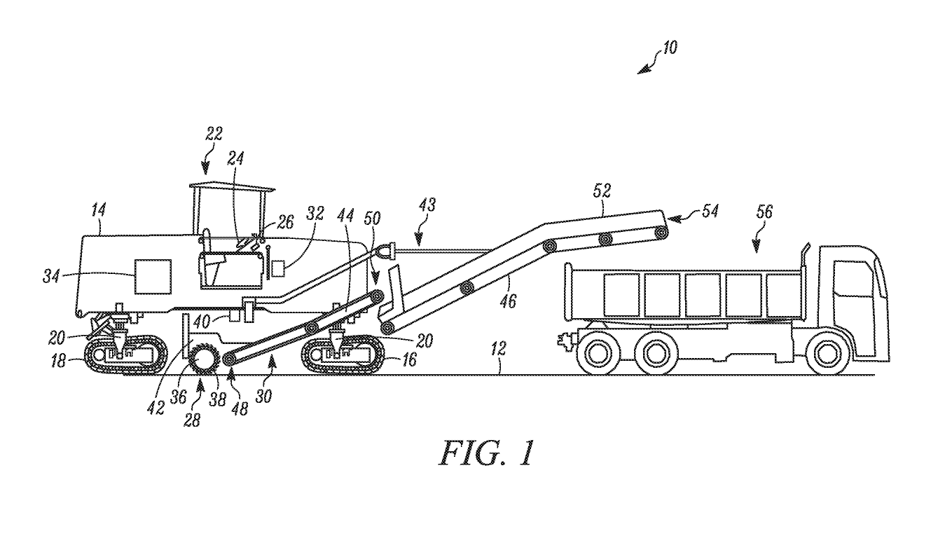

### DETAILED DESCRIPTION

Wherever possible, the same reference numbers will be used throughout the drawings to refer to same or like parts. FIG. 1 illustrates an exemplary machine 10, in accordance with the present disclosure. The machine 10 may be a mobile machine operable to move along a ground surface 12 that is underneath the machine 10. The ground surface 12 may be a man-made surface, such as a road, parking lot, concrete cement, or other paved surface. The machine 10 may be configured to perform various functions when traveling over the ground surface 12. In the embodiment shown in FIG. 1, the machine 10 is a cold planer. The machine 10 may cut or grind a top layer of concrete, asphalt, or similar material, to a depth that is typically between 1″ to 14″ below the ground surface 12.

The machine 10 may include a frame 14 supported by one or more front ground engaging units 16 and one or more rear ground engaging units 18. The ground engaging units 16, 18 may each include either a wheel or a track section that is pivotable in one or more directions. The ground engaging units 16 and/or 18 are connected to lifting columns 20, which may be adapted to controllably raise and lower the frame 14 relative to the associated ground engaging units 16, 18.

The frame 14 supports an operator's station 22 having a steering command element 24 and a controller 26. The steering command element 24 is shown to include a steering wheel, but other steering devices such as a joystick or levers could be used as well. The controller 26 may send control signals to one or more actuators (not shown) of the following: the ground engaging units 16, 18, the lifting columns 20, a milling system 28 and a debris removal system 30. In the case of electrically activated actuators, the control signals may act directly on the respective actuators. In the case of hydraulically activated actuators, the control signals may act on valves, which in turn control flows of pressurized fluid to the actuators. The controller 26 may be a separate control unit or may be part of a central control unit operable to control additional functions of the machine 10.

The frame 14 may also support a water tank 32, an engine 34 such as an internal combustion engine, and the milling system 28. The engine 34 may supply power to drive one or more of ground engaging units 16, 18 to propel the machine 10 relative to the ground surface 12. In one embodiment, this is accomplished by driving a hydraulic pump with an output of the engine 34, which in turn supplies high-pressure hydraulic fluid to individual motors associated with the ground engaging units 16, 18. This conventional hydraulic drive is well-known in the pertinent art and is therefore not depicted in the drawings. The engine 34 may also supply power to the milling system 8 to break up the ground surface 12.

The milling system 28 may include various components that interact to remove asphalt from the ground surface 12. In the illustrated embodiment, the milling system 28 includes a milling drum 36, a plurality of cutting tools 38, a water nozzle 40 and a milling drum housing 42. The cutting tools 38 may be attached to the milling drum 36 in any manner known in the art. During the milling process, the cutting tools 38 may be frictionally heated on account of their sustained contact with the ground surface 12. The water nozzle 40 may spray water on the milling drum 36 and the cutting tools 38 during the operation of the milling system 28 to cool the same. The milling system 28 may remove a layer of asphalt from the entire width of the ground surface 12 or from only a portion of the ground surface 12 at varying depths and contours, The broken-up road material may be carried away from the machine 10 by the debris removal system 30.

The debris removal system 30 may include various components that cooperate to remove milled asphalt from the milling system 28. In the illustrated embodiment, the debris removal system 30 includes a conveyor system 43 having a primary conveyor 44 and a secondary conveyor 46. The cutting tools 38 may be configured to deliver milled asphalt onto a charge end 48 of the primary conveyor 44 as the milling drum 36 rotates towards the primary conveyor 44. The milled asphalt exits from a throw-off end 50 of the primary conveyor 44 and may fall on the secondary conveyor 46. The debris removal system 30 may include various other components such as a dust suppression system etc. (not shown) as well as suitable to the need of the present disclosure.

The milled asphalt, being transported by the secondary conveyor 46 may be kept from prematurely exiting secondary conveyor 46 (i.e., kept from spilling off sides) by a secondary conveyor housing 52. The secondary conveyor 46 may discharge the milled asphalt at a discharge end 54. The milled asphalt may be off-loaded to any appropriate transport vehicle 56, such as an on-highway haul truck, an off-highway articulated or non-articulated truck, or any other type of transport vehicle known in the art. In an embodiment, the primary conveyor 44 may directly transfer the milled material to the transport vehicle 56 and the secondary conveyor 46 may not be required at all.

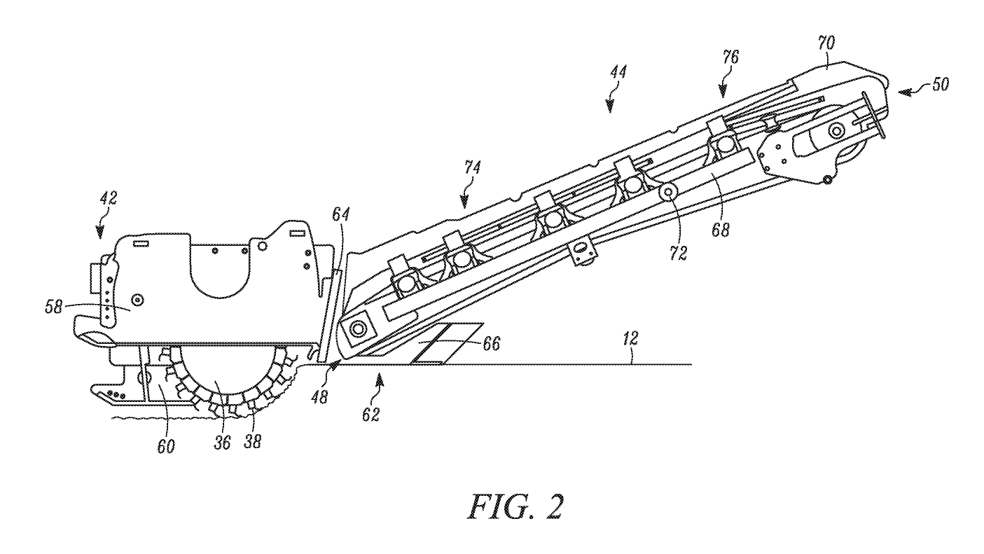

Further details of the milling system 28 and the debris removal system 30 are illustrated in FIG. 2. The milling drum housing 42 includes a first side plate 58 and a second side plate 60. The first and second side plates 58, 60 can move in at least a vertical direction. The first side plate 58 is illustrated at a higher height from the ground surface 12 compared to the second side plate 60. However, it should be contemplated that the first and second side plates 58, 60 may move simultaneously or independently and can be positioned at same of different heights from the ground surface 12. The machine 10 further includes an anti-slabbing mechanism 62 coupled to the frame 14.

The anti-slabbing mechanism 62 prevents breaking up of large slabs/chunks of asphalt from the ground surface 12. The anti-slabbing mechanism includes an upwardly oriented base plate 64 extending across a front side of the milling system 28, a forwardly projecting plow 66 for plowing loose material lying upon the ground surface 12, and a plurality of skids (not shown). The anti-slab mechanism 62 may include other parts as well suitable to the scope of the present disclosure. The primary conveyor 44 is positioned forwardly of the base plate 64, and may be coupled to and supported upon the base plate 64, for feeding milled material from the ground surface 12 by the milling system 28 to the secondary conveyor 46 or the transport vehicle 56, The primary conveyor 44 may be coupled to the base plate 64 in any manner suitable to the present disclosure.

As the depth of cut of the milling drum 36 needs to be varied in various applications, the first and second side plates 58, 60 and the anti-slabbing mechanism 62 are adjusted. The position of the milling drum 36 may remain constant with respect to the frame 14 as the first and second side plates 58, 60 and the anti-slabbing mechanism 62 are moved upwards and downwards to increase and decrease the depth of cut of the milling drum 36 respectively. Upward movement of the first and second side plates 58, 60 and the anti-slabbing mechanism 62 allows the milling drum 36 to have greater access to the ground surface 12. Thereafter, the cutting tools 38 thrust with greater force in the ground surface 12 thereby milling more material. The position of the primary conveyor 44 changes at the charge end 48 due to the movement of the anti-slab mechanism 62 as the primary conveyor 44 is coupled to the base plate 64. It should be understood that other arrangements for increasing/decreasing the depth of cut of the rotor may also be possible and the explained arrangement is merely exemplary in nature.

The primary conveyor 44 includes a conveyor frame 68 and a conveyor belt 70 around the conveyor frame 68 to carry the milled material. The conveyor belt 70 receives the milled material at the charge end 48 of the primary conveyor 44 and transfers the material to the secondary conveyor 46 or the transport vehicle 56 at the throw-off end 50. The throw-off end 50 may be attached to the frame 14 of the machine 10 to keep the position of the throw-off end 50 constant. The throw off-end 50 may rest on a plate or a slide (not shown) attached to the frame 14 of the machine 10. The conveyor frame 68 may include side plates and seals (not shown) to prevent milled material from being spilled while the milled material is carried between the charge end 48 and the throw-off end 50. The conveyor frame 68 further includes a hinge mechanism 72 dividing the conveyor frame 68 in a first portion 74 and a second portion 76.

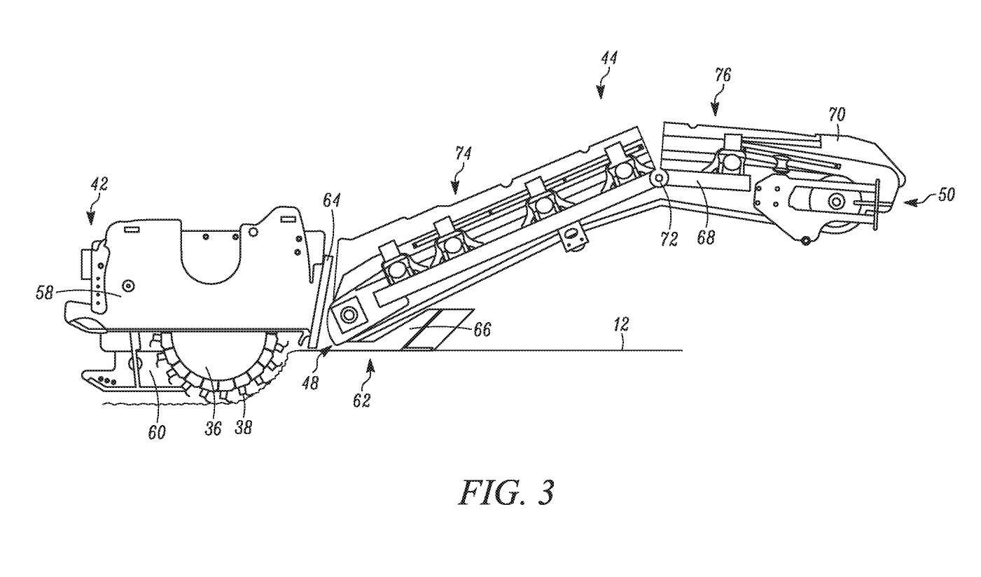

The first portion 74 is defined as the part of the conveyor frame 68 including the charge end 48 and the second portion 76 is defined as the part of the conveyor frame 68 including the throw-off end 50. The hinge mechanism 72 allows relative movement of the first and second portions 74. 76 of the conveyor frame 68 as illustrated in FIG. 3. As the depth of cut of the milling drum 36 changes, correspondingly the position of the first and second side plates 58, 60 and the anti-slabbing mechanism 62 changes as well. As the primary conveyor 44 is coupled with the anti-slabbing mechanism 62, there is a corresponding change in the position of the first portion 74 of the conveyor frame 68, However, as the hinge mechanism 72 is located between the first and second portions 74, 76 of the conveyor frame 68, the hinge mechanism 72 allows the position of the throw-off end 50 to remain the same. The hinge mechanism 72 may be a standard hinge mechanism suitable to the need of the present disclosure.

Although the present disclosure has been described with a particular configuration of the machine 10, it should be contemplated that various other models and configurations of the machine 10 may be possible where the present disclosure may be applied. For example the position of the milling system 28 may be varied to be located at a rear end of the machine 10 as opposed to in the central position as illustrated. Also, the relative positions of anti-slabbing mechanism 62 and the conveyor system 43 may be varied according to the size and configuration of a particular model of the machine 10.

### INDUSTRIAL APPLICABILITY

Conveyors are often used to move material in a variety of settings. One example setting, but by no means, is a limiting example, is the use of a conveyor to move asphalt or other roadbed material from a cold planer machine to another vehicle. The second vehicle is often used to haul away the material moved by the conveyor. Due to the variety of settings and equipment that may be used in a milling operation, it may be desirable to provide a wide range of locations for the output of the material carried by the conveyor. One way to provide a multiple of locations for the output of the material may be to provide a system of multiple conveyors. A position of the conveyor becomes vital in defining the flow of material from the roadway to the transport vehicle. A throw-off end of the conveyor should remain at a constant position relative to a second conveyor or a transport vehicle.

The present disclosure provides a solution to the problems by offering an improved design of the conveyor system 43 of the machine 10. The conveyor system 43 includes the primary conveyor 44. The primary conveyor 44 includes the conveyor frame 68 adapted to receive the conveyor belt 70 to convey the milled material. The primary conveyor 44 includes the hinge mechanism 72 which divides the conveyor frame 68 in the first portion 74 having the charge end 48 and the second portion 76 having the throw-off end 50. As the position of the first portion 74 of the conveyor frame 68 changes, there is no change in the position of the throw-off end 50 of the second portion 76 due to the hinge mechanism 72. Hence, the position of the throw-off end 50 remains constant even as the position of the charge end 48 of the first portion 74 of the conveyor frame 68 may undergo Change in position.

Constant position of the throw-off end 50 contributes towards increasing productivity of the machine 10 as there is no need to adjust the position of the primary conveyor 44 relative to the secondary conveyor 46 or the transport vehicle 56 Whenever the depth of cut of the milling drum is altered. The primary conveyor 44 is now designed such as to compensate for the change in position and keep the throw-off end 50 at constant position. If the primary conveyor 44 is delivering the milled material to the secondary conveyor 46, the present disclosure ensures that there is no gap and sealing difficulties between the primary and secondary conveyors 44, 46 due to the change in position of the first portion 74 of the conveyor frame 68 and the milled material is transferred smoothly to the secondary conveyor 46, Further, the hinge mechanism 72 being a simple system does not adds up any complexity to the machine 10 making it easier to service/repair if required for maintenance purposes.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A cold planer having a conveyor system, the conveyor system comprising:
a conveyor frame adapted to receive a conveyor belt, the conveyor frame including:
a first portion of the conveyor frame coupled to an anti-slab mechanism, the first portion adapted to undergo a change in position corresponding to a movement of the anti-slab mechanism;
a second portion of the conveyor frame, the second portion having a throw-off end adapted to release a material being conveyed on the conveyor system; and
a hinge mechanism disposed between the first portion of the conveyor frame and the second portion of the conveyor frame, the hinge mechanism adapted to allow the throw-off end of the second portion to remain at a fixed position corresponding to the movement of the anti-slab mechanism.
